(19) United States
(12) Patent Application Publication
(10) Pub. No.: US 2025/0142606 A1
(43) Pub. Date: May 1, 2025

(54) SERVICE PERIOD PARAMETER SCHEDULING FOR FRAME EXCHANGE PROCEDURES

(71) Applicant: QUALCOMM Incorporated, San Diego, CA (US)

(72) Inventors: Alfred ASTERJADHI, San Diego, CA (US); Abdel Karim AJAMI, San Diego, CA (US); George CHERIAN, San Diego, CA (US); Abhishek Pramod PATIL, San Diego, CA (US); Gaurang NAIK, San Diego, CA (US); Yanjun SUN, San Diego, CA (US); Sai Yiu Duncan HO, San Diego, CA (US)

(21) Appl. No.: 18/496,676

(22) Filed: Oct. 27, 2023

(51) Int. Cl. H04W 72/51; H04W 72/1263

(52) U.S. Cl. CPC H04W 72/51; H04W 72/1263

(57) ABSTRACT

This disclosure provides methods, components, devices, and systems for service period parameter scheduling for frame exchange procedures. In some examples, a first wireless device (such as an access point (AP), a station (STA)), may communicate with a second wireless device (such as a STA, an AP) during a scheduled service period. The first wireless device may indicate an upper or lower limit for communication parameters used by the first wireless device and the second wireless device during the service period. The first wireless device may communicate with the second wireless device according to the limited parameters. In some examples, the first wireless device may be available to communicate with other wireless devices outside of the scheduled service period. In such examples, the first wireless device may communicate with the other wireless devices according to a second set of parameters indicated alongside the first set of parameters.

### TECHNICAL FIELD

This disclosure relates to wireless communication and, more specifically, to service period parameter scheduling for frame exchange procedures.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication by a first wireless device. The method may include transmitting one or more first frame exchange parameters associated with a scheduled service period, where the first wireless device is available for wireless communications with one or more second wireless devices during the scheduled service period, and communicating with the one or more second wireless devices during the scheduled service period in accordance with the one or more first frame exchange parameters.

Another innovative aspect of the subject matter described in this disclosure can be implemented by a first wireless device for wireless communications. The first wireless device may include a processing system that includes processor circuitry and memory circuitry that stores code. The processing system may be configured to cause the first wireless device to transmit one or more first frame exchange parameters associated with a scheduled service period, where the first wireless device is available for wireless communications with one or more second wireless devices during the scheduled service period, and communicate with the one or more second wireless devices during the scheduled service period in accordance with the one or more first frame exchange parameters.

In some examples of the method and first wireless devices described herein, communicating with the one or more second wireless devices may include operations, features, means, or instructions for transmitting a control frame during the scheduled service period in accordance with a capability of the first wireless device, where the first wireless device transmits the control frame during the scheduled service period and the control frame indicates a start of the first wireless device using the one or more first frame exchange parameters during the scheduled service period.

Some examples of the method and first wireless devices described herein may further include operations, features, means, or instructions for transmitting a frame indicating a capability of the first wireless device to support applying different frame exchange parameters during different scheduled service periods, where communicating with the one or more second wireless devices during the scheduled service period may be in accordance with the capability.

Some examples of the method and first wireless devices described herein may further include operations, features, means, or instructions for communicating with one or more third wireless devices during a second period outside of the scheduled service period in accordance with one or more second frame exchange parameters, where a duration of the second period may be defined in accordance with a capability of the first wireless device, a capability of a second wireless device, or both.

Another innovative aspect of the subject matter described in this disclosure can be implemented in a method for wireless communications by a second wireless device. The method may include receiving one or more first frame exchange parameters associated with a scheduled service period, where the second wireless device is available for wireless communications with one or more first wireless devices and communicating with the one or more first wireless devices during the scheduled service period in accordance with the one or more first frame exchange parameters.

Another innovative aspect of the subject matter described in this disclosure can be implemented by a second wireless device for wireless communications. The second wireless device may include a processing system that includes processor circuitry and memory circuitry that stores code. The processing system may be configured to cause the second wireless device to receive one or more first frame exchange parameters associated with a scheduled service period, where the second wireless device is available for wireless communications with one or more first wireless devices and communicate with the one or more first wireless devices during the scheduled service period in accordance with the one or more first frame exchange parameters.

In some examples of the method and second wireless devices described herein, communicating with the one or more first wireless devices may include operations, features, means, or instructions for receiving a control frame during the scheduled service period in accordance with a capability of the second wireless device, where the second wireless device receives the control frame during the scheduled service period and the control frame indicates a start of the second wireless device using the one or more first frame exchange parameters during the scheduled service period.

Some examples of the method and second wireless devices described herein may further include operations, features, means, or instructions for receiving a frame indicating a capability of the one or more first wireless devices to support applying different frame exchange parameters during different scheduled service periods, where communicating with the one or more first wireless devices during the scheduled service period may be in accordance with the capability.

Some examples of the method and second wireless devices described herein may further include operations, features, means, or instructions for communicating with the one or more first wireless devices according to a first operational mode, where the second wireless device enters the first operational mode in accordance with the one or more first frame exchange parameters.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a communications timeline that supports service period parameter scheduling for frame exchange procedures.

FIG. 3 shows an example of a process flow that supports service period parameter scheduling for frame exchange procedures.

FIG. 4 shows a block diagram of an example wireless communication device that supports service period parameter scheduling for frame exchange procedures.

FIGS. 5 and 6 show flowcharts illustrating example processes performable by or at a first wireless device that supports service period parameter scheduling for frame exchange procedures.

FIGS. 7 and 8 show flowcharts illustrating example processes performable by or at a second wireless device that supports service period parameter scheduling for frame exchange procedures.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to wireless communication and more particularly to service period parameter scheduling for frame exchange procedures. In some examples, a first wireless device (such as an access point (AP) or a station (STA)), may communicate with a second wireless device (such as a STA or an AP) during a scheduled service period. The first wireless device may transmit an indication of frame exchange parameters associated with communicating during the scheduled service period. Examples of such frame exchange parameters may include one or more of: a quantity of spatial streams, a physical protocol data unit (PPDU) format, a bandwidth for transmitting or receiving, one or more subchannels within the bandwidth for communicating with the second wireless device, a modulation and coding scheme (MCS), a transmit power, a medium access control protocol data unit (MPDU) start spacing, a quantity of MPDUs within an aggregate MPDU (A-MPDU), an aggregate medium access control service data unit (A-MSDU) utilization, a fragmentation utilization, a quantity of padding, an enhanced multi-link single radio ((e)MLSR) mode, a simultaneous transceiver (STR) mode, a non-simultaneous transceiver (NSTR) mode, or a combination thereof. In some implementations, one or more of such frame exchange parameters may be expressed as an actual parameter, a minimum parameter, a maximum parameter, or a range. In some implementations, the first wireless device may indicate a first set of frame exchange parameters for communications associated with the first wireless device. Similarly, the second wireless device may indicate a second set of frame exchange parameters for communications associated with the second wireless device.

For example, the first wireless device may indicate an upper or lower limit for frame exchange parameters used by the first wireless device (such as the first set of frame exchange parameters) to communicate with the second wireless device during the service period. In some implementations, the first wireless device may use the indicated frame exchange parameters after transmitting or receiving an explicit control frame within or otherwise associated with the service period. In some implementations where the first wireless device does not receive the control frame, an absence of the control frame may indicate that a third set of parameters (such as an additional set of parameters associated with the first wireless device) may be used within the service period, outside of the service period, or both. In some implementations, the first wireless device and the second wireless device may communicate according to the indicated frame exchange parameters within the service period without receiving the explicit control frame. Additionally, the first wireless device may communicate with other wireless devices outside of the scheduled service period using a second set of frame exchange parameters that is different from the frame exchange parameters signaled for the scheduled service period.

Particular aspects of the subject matter described in this disclosure can be implemented to realize one or more of the following potential advantages. By configuring frame exchange parameters associated with a service period during the scheduling of the service period, aspects of the present disclosure may enhance coexistence between two or more radios associated with different radio access technologies (RATs) of the first wireless device. More specifically, service period-based frame exchange parameter scheduling may free up communication resources (such as spatial streams, bandwidth, a modulation and coding scheme (MCS)) that may otherwise go unused during a service period. For example, the first wireless device may be configured to communicate with the second device using a portion of the communication resources available to the first wireless device during the service period. By enforcing a limit on each communication resource, the first wireless device may communicate with other wireless devices using the remaining communication resources. Additionally, by configuring frame exchange parameters for service groups during service period scheduling, the first wireless device may avoid signaling new frame exchange parameters before the start of each service group, thereby reducing signaling overhead between the first wireless device and the second wireless device. This reduction of overhead signaling and improvement in coexistence between radios may result in greater spectral utilization, improved network throughput, improved power efficiency, and a better overall user experience.

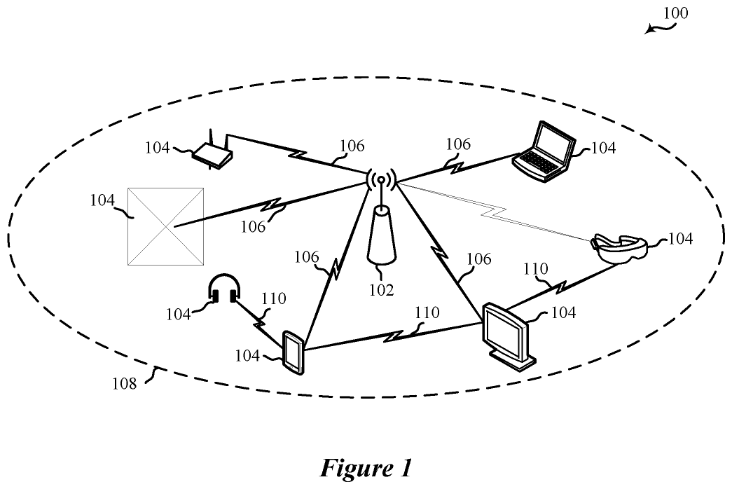

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless AP 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHZ, 5 GHZ, 6 GHz, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHZ-7.125 GHZ), FR2 (24.25 GHZ-52.6 GHZ), FR3 (7.125 GHZ-24.25 GHZ), FR4a or FR4-1 (52.6 GHZ-71 GHZ), FR4 (52.6 GHZ-114.25 GHZ), and FR5 (114.25 GHZ-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHZ, but larger channels can be formed through channel bonding. For example, PPDUs may be transmitted over physical channels having bandwidths of 40 MHZ, 80 MHZ, 160 MHZ, 240 MHZ, 320 MHz, 480 MHZ, or 640 MHz by bonding together multiple 20 MHz channels.

In some examples, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (such as High Efficiency (HE) systems or other legacy systems). For example, the IEEE 802.11 be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHZ, 40 MHz, 80 MHZ, 160 MHZ, 240 MHZ, and 320 MHZ. EHT systems may support multiple bandwidth modes such as a contiguous 240) MHz bandwidth mode, a contiguous 320) MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHZ (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHZ bandwidth mode, or a noncontiguous 160+80 MHz bandwidth mode, the signals for transmission may be generated by three different transmit chains of the wireless communication device, each having a bandwidth of 80 MHZ. In some other examples, signals for transmission may be generated by four or more different transmit chains of the wireless communication device, each having a bandwidth of 80 MHZ.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QOS) parameters. For example, existing technology (such as IEEE 802.11 ax standard amendment protocols) supports the use of up to 1024-QAM, where a modulated symbol carries 10 bits. To further improve peak data rate, each of the AP 102 or the STA 104 may employ use of 4096-QAM (also referred to as “4k QAM”), which enables a modulated symbol to carry 12 bits. 4k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 us per OFDM symbol). The AP 102 or the STA 104 using 4096-QAM may enable a 20% increase in data rate compared to 1024-QAM given the same coding rate, thereby allowing users to obtain higher transmission efficiency.

In some examples, a first wireless device and a second wireless device of the wireless communication network 100 may exchange frames in accordance with one or more frame exchange parameters. In some implementations, the first wireless device may be an AP 102, and the second wireless device may be a STA 104. In some other implementations, the first wireless device may be a STA 104, and the second wireless device may be an AP 102. In some implementations, the AP 102 may indicate the frame exchange parameters (such as the first set of frame exchange parameters) during service period scheduling. In some other implementations, the STA 104 may indicate the frame exchange parameters (such as the second set of frame exchange parameters). Additionally, or alternatively, the first wireless device and the second wireless device may communicate according to parameters that are common across both the first set of frame exchange parameters and the second set of frame exchange parameters. The AP 102 and the STA 104 may exchange frames during a service period that is shared between both the AP 102 and the STA 104 (such as during an overlap between an AP-associated service period and a STA-associated service period). For example, the AP 102 may broadcast a frame indicating the frame exchange parameters and at least one service period during which the AP 102 is available to communicate with the STA 104. The STA 104 may receive the frame and may transmit a request frame to the AP 102 indicating at least one service period during which the STA 104 is available to communicate with the AP 102. The frame exchange parameters may be applicable to all frames that are transmitted from the first wireless device, to all frames that are transmitted from the second wireless device to the first wireless device, or both. To facilitate communicating latency-sensitive traffic, the AP 102 may operate according to a high-power state to communicate with the STA 104, and vice versa. In some implementations, the AP 102 may be available to communicate with one or more other devices during an AP-associated service period that does not overlap with a STA-associated service period.

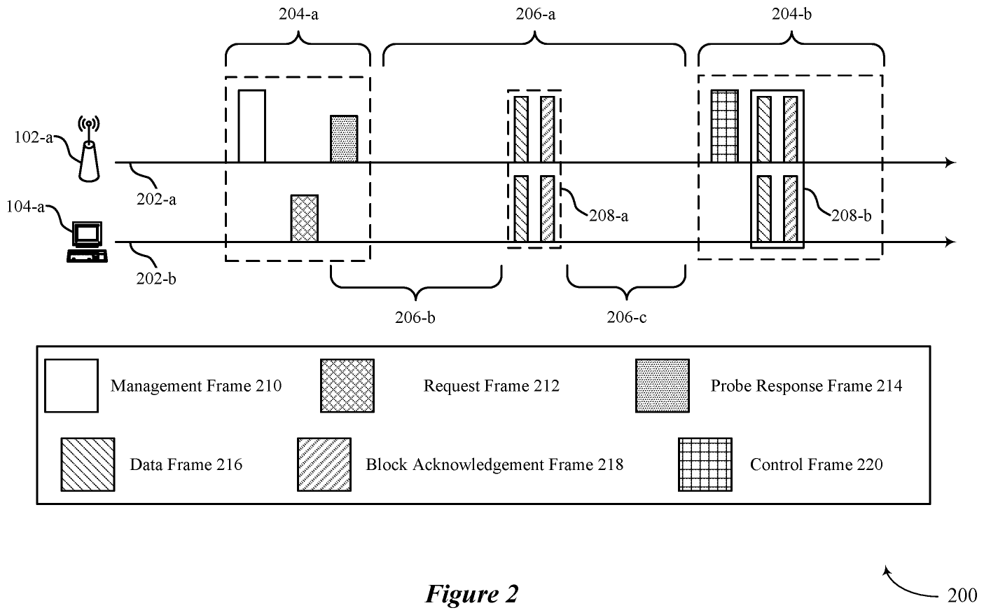

FIG. 2 shows an example of a communications timeline 200 that supports service period parameter scheduling for frame exchange procedures. The communications timeline 200 may illustrate an example for implementing one or more aspects of the wireless communication network 100. For example, the communications timeline 200 may depict or represent a flow of communications (such as signals, messages) between an AP 102-a and a STA 104-a. The AP 102-a may be an example of one or more aspects of an AP 102 as described herein, including with reference to FIG. 1. The STA 104-a may be an example of one or more aspects of a STA 104 as described herein, including with respect to FIG. 1. In some examples, the horizontal axis 202-a of the communications timeline may represent a time component of signaling transmitted by the AP 102-a, and the horizontal axis 202-b may represent a time component of signaling transmitted by the STA 104-a.

In some examples, the AP 102-a may communicate with multiple STAs 104, including the STA 104-a. The AP 102-a, the STA 104-a, or both the AP 102-a and the STA 104-a may operate according to a power saving mode. For example, a first device (such as, the AP 102-a) may switch (such as periodically, aperiodically, semi-periodically) between a high-power state and a low-power state. When operating in a high-power state, the first device may be available to communicate with a second device (such as the STA 104-a). Conversely, when operating in a low-power state, the first device may communicate with devices other than the STA 104-a. In some examples, the other devices may operate according to a radio access technology (RAT) that is different from the STA 104-a (such as Bluetooth, Cellular New Radio (NR)). The AP 102-a and the STA 104-a may operate according to the high-power state during a service period. For example, the AP 102-a may operate according to a high-power state during the AP service period 204-a and the AP service period 204-b and may operate according to a low-power state for a duration 206-a outside of the AP service period 204-a and the AP service period 204-b.

Similarly, the STA 104-a may operate according to a high-power state during the STA service period 208-a and the STA service period 208-b, and may operate according to a low-power state for a duration 206-b and a duration 206-c outside of the STA service period 208-a and the STA service period 208-b. The AP 102-a and the STA 104-a may communicate (such as by exchanging frames) with each other when the respective service periods associated with the AP 102-a and the STA 104-a overlap (such as in time). For example, the STA 104-a may exchange frames with the AP 102-a during the STA service period 208-b that overlaps with the AP service period 204-b. Similarly, the STA 104-a may not exchange frames with the AP 102-a during the STA service period 208-a that does not overlap with the AP service period 204-a.

In some examples, the AP 102-a may broadcast AP scheduling information to one or more STAs, including the STA 104-a. The AP scheduling information may indicate service periods associated with the AP 102-a (such as the AP service period 204-a and the AP service period 204-b). Additionally, the AP scheduling information may be associated with an identifier (such as a broadcast target wait time identifier (B-TWT ID)) indicating that the AP scheduling information applies to all STAs 104 communicating with the AP 102-a. The AP 102-a may broadcast the AP scheduling information via a management frame 210 (such as a beacon frame, a probe association frame, a Tunneled Direct Link Setup (TDLS) frame, or an operation mode notification frame). The AP scheduling information may indicate that the AP service period 204-a and the AP service period 204-b are associated with a bit value (such as a responder power management mode bit) indicating that the AP 102-a is in a first mode of operation (such as a high-power mode or a low-power mode) during the AP service period 204-a and the AP service period 204-b.

The STA 104-a may receive the broadcast management frame 210 from the AP 102-a and may transmit a request frame 212 to the AP 102-a indicating STA scheduling information, including an indication of service periods associated with the STA 104-a (such as the STA service period 208-a and the STA service period 208-b). The STA scheduling information may indicate that the STA service period 208-a and the STA service period 208-b are associated with a bit value (such as a request power management mode bit value) indicating that the STA 104-a is in a first mode of operation (such as a high-power mode or a low-power mode) during the STA service period 208-a and the STA service period 208-b. The STA 104-a may exchange frames (such as control frames, data frames, management frames) with the AP 102-a during a service period associated with both the identifier and the bit value indicated in the management frame 210. The AP 102-a may respond to the request frame 212 with a response frame 214 and may schedule service periods in accordance with the STA scheduling information. After service period scheduling, the AP 102-a and the STA 104-a may communicate data frames 216 and block acknowledgement frames 218 during the AP service period 204-b that overlaps with the STA service period 208-b.

In some other implementations, the AP 102-a and the STA 104-a may communicate without negotiating a shared service period. For example, the AP 102-a may indicate the AP scheduling information to the STA 104-a and the STA 104-a may communicate with the AP 102-a without transmitting the request frame 212. The STA 104-a may not indicate, to the AP 102-a, the STA scheduling information before communicating with the AP 102-a. Similarly, the STA 104-a may indicate STA scheduling information to the AP 102-a, and the AP 102-a may communicate with the STA 104-a without transmitting management frames (such as the management frame 210 or the request frame 212) to the STA 104-a. The AP 102-a may not indicate, to the STA 104-a, the AP scheduling information before communicating with the STA 104-a.

The AP 102-a may be configured with communication resources (such as spatial streams, a bandwidth (BW), a modulation and coding scheme (MCS)) that are available for use to communicate with other devices. In some examples, the AP 102-a and the STA 104-a may communicate according to a set of frame exchange parameters indicated by the AP 102-a. The AP 102-a may indicate the set of frame exchange parameters via the management frame 210) or the response frame 214. The set of frame exchange parameters may be further associated with the resources configured to and available at the AP 102-a. In some examples, the set of frame exchange parameters may indicate an upper limit (such as a maximum value) on the available resources used for communications between the AP 102-a and the STA 104-a. For example, the set of frame exchange parameters may indicate that a maximum of four spatial streams over a maximum of 320 MHz can be used for communications between the AP 102-a and the STA 104-a. In some other examples, the set of frame exchange parameters may indicate a lower limit (such as a minimum value) on the available resources used for communications between the AP 102-a and the STA 104-a. For example, the set of frame exchange parameters may indicate that a minimum of one spatial stream over a minimum of 20 MHz can be used for communications between the AP 102-a and the STA 104-a. Additionally, or alternatively, the set of frame exchange parameters also may include an indication of an operational mode of the AP 102-a.

The frame exchange parameters may include a quantity of spatial streams, a PPDU format, a BW, a MCS, a transmit power, a MPDU minimum start spacing, a quantity of MPDUs within an A-MPDU, A-MSDU utilization, fragmentation utilization, a quantity of padding, an enhanced multi-link single radio ((e)MLSR) mode, an enhanced multi-link multi-radio ((e)MLMR) mode, a simultaneous transceiver (STR) mode, a non-simultaneous transceiver (NSTR) mode or any combination thereof. In some examples, the PPDU format may include one or more of an ultra-high-reliability (UHR) PPDU, an extended range PPDU, an EHT PPDU, a HE PPDU, a high-throughput (HT) PPDU, or any combination thereof.

The AP 102-a may be configured to communicate according to a different set of frame exchange parameters for each associated service period. For example, the AP 102-a may be configured to communicate during the AP service period 204-a using four spatial streams over a bandwidth of 80 MHz but may communicate during the AP service period 204-b using four spatial streams over a bandwidth of 320 MHZ. In some examples, the set of frame exchange parameters may indicate a larger limit for a service period (such as the AP service period 204-b) in accordance with latency-sensitive traffic (such as extended reality (XR) traffic, ultra-reliable low latency communications (URLLC) traffic) scheduled at the AP 102-a during the service period. Similarly, the set of frame exchange parameters for a service period associated with non-latency-sensitive traffic may indicate a smaller limit for the service period. The STA 104-a also may be configured to use a different set of frame exchange parameters for each associated service period. For example, the STA 104-a may be configured to communicate during the STA service period 208-a using 4 spatial streams over a bandwidth of 80 MHz but may communicate during the STA service period 208-b using two spatial streams.

In some examples, the AP 102-a also may communicate according to a different set of frame exchange parameters for different communication links. For example, the AP 102-a may communicate according to a first set of frame exchange frame exchange parameters (such as frame exchange parameters associated with a relatively higher power consumption or output) when communicating with the STA 104-a during the AP service period 204-b that overlaps with the STA service period 208-b. Similarly, the AP 102-a may communicate according to a second set of frame exchange parameters (such as frame exchange parameters associated with a relatively lower power consumption or output) when communicating with devices other than the STA 104-a during the duration 206-a that does not overlap with the STA service period 208-b. Additionally, or alternatively, the AP 102-a, the STA 104-a, or both may be configured to communicate using different operational modes. For example, the AP 102-a may implement in-device coexistence using shared components (such as receive chains and transmit chains) to communicate over multiple RATs (such as Wi-Fi and 5G), and as such, some or all of the shared components may be unavailable for communicating with the STA 104-a at certain times. In accordance with communicating the frame exchange parameters, the STA 104-a may determine, calculate, obtain, ascertain, or select to enter a joint-operation mode for a period of time and may determine, calculate, obtain, ascertain, or select to exit or tear down the joint-operation mode and return to the default mode. In this way, the STA 104-a may communicate with the AP 102-a during an agreed upon service period when the AP 102-a has allocated or dedicated resources to communicating with the STA 104-a.

The STA 104-a may exchange frames with the AP 102-a during a STA-associated service period that overlaps with an AP-associated service period. For example, the STA 104-a may exchange frames with the AP 102-a during the STA service period 208-b that overlaps with the AP service period 204-a. Additionally, the STA 104-a may communicate with the AP 102-a in accordance with the limit indicated by the AP 102-a. For example, the AP 102-a, the STA 104-a, or both may enforce the limit on the set of frame exchange parameters in accordance with communicating the management frame 210. Similarly, the AP 102-a, the STA 104-a, or both may not enforce the limit if the STA 104-a does not receive the management frame 210 from the AP 102-a. In some examples, the STA 104-a may indicate identifying information (such as a traffic identifier (TID), an access category (AC)) associated with traffic communicated between the STA 104-a and the AP 102-a, and the AP 102-a may enforce the limit according to the identifying information. For example, the STA 104-a may indicate a TID associated with voice data traffic to the AP 102-a, and the AP 102-a may enforce the configuration for communications with a TID that matches the indicated TID.

In some examples, the AP 102-a, the STA 104-a, or both may utilize unavailable periods to facilitate transitioning between frame exchange parameter configurations (such as between a high-power state and a low-power state, and vice-versa). During an unavailable period, the AP 102-a, the STA 104-a, or both may be unable to communicate with other devices. Unavailability periods may be scheduled according to device capability. For example, the AP 102-a may indicate a capability of the AP 102-a to support multiple frame exchange parameter configurations in a transmitted frame, such as the management frame 210 or the response frame 214. The STA 104-a may receive the indication and schedule available periods (such as service periods) accordingly. Similarly, the STA 104-a may indicate a capability of the STA 104-a to support multiple frame exchange parameter configurations in a transmitted frame, such as the request frame 212, and the AP 102-a may schedule service periods accordingly.

In some examples, the AP 102-a, the STA 104-a, or both may be configured to transmit a control frame 220 (such as an initial control frame (ICF)) at the beginning of an availability period. In some examples, the control frame 220 may include the indication of the frame exchange parameter configuration. Additionally, or alternatively, the STA 104-a may indicate a padding (such as signal padding) amount, and the AP 102-a may transmit the control frame 220 to provide signal padding. For example, the STA 104-a may be available to communicate with other devices operating using at least a limited capability. In such examples, the STA 104-a may be configured to transmit a control frame 220 at the beginning of each service period (such as the STA service period 208-a, the STA service period 208-b) to facilitate transitioning between a high-power state and a low-power state, and vice-versa.

In some examples, the AP 102-a, the STA 104-a, or both may transmit the control frame 220 according to a PPDU type, a quantity of spatial streams, an MCS, or any combination thereof, configured for communications between the AP 102-a and the STA 104-a. For example, the AP 102-a, the STA 104-a, or both may transmit the control frame 220 in accordance with being configured to communicate using a non-high-throughput (non-HT) duplicate or an ultra-high-reliability (UHR) duplicate PPDU format using 1 spatial stream and using less than 24 megabits-per-second (Mbps). In some examples, the control frame 220 may be a request-to-send (RTS) frame, a multi-user RTS (MU-RTS) frame, or a Buffer Status Report Poll (BSRP) Trigger frame. In some examples, receiving the control frame 220 may trigger the device that received the control frame 220 to enforce the limit on the frame exchange parameters. In some examples, there may be additional rules configured at the AP 102-a, the STA 104-a, or both indicating to use a quantity of spatial streams that is less than or equal to the quantity of spatial streams indicated in the control frame 220 or a first PPDU (such as transmitted within a transmission opportunity transmitted within a service period).

In some examples, the AP 102-a or the STA 104-a may transmit a frame indicating for early termination of service period shared by the AP 102-a and the STA 104-a. In such examples, in accordance with receiving the indication, the STA 104-a or the AP 102-a may switch to a low-power state (such as enforcing a smaller limit on frame exchange parameters) and may resume communications accordingly.

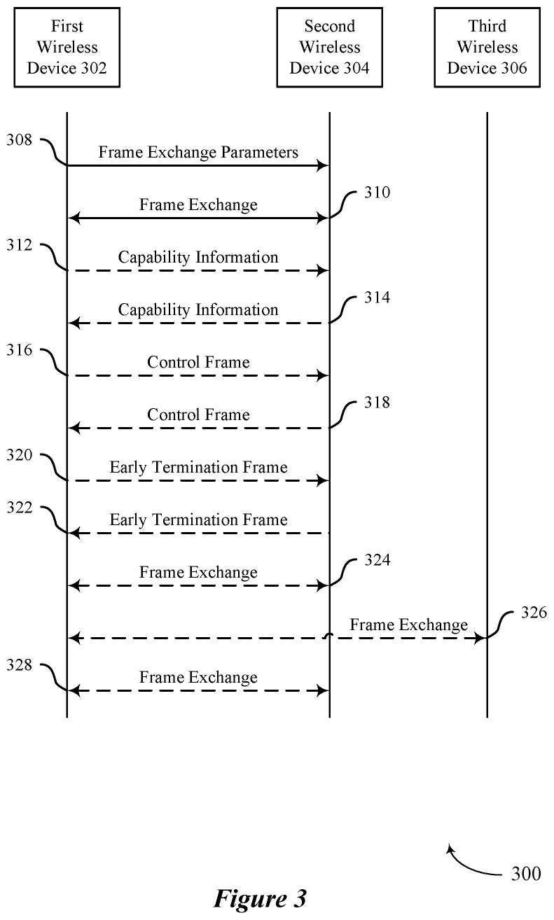

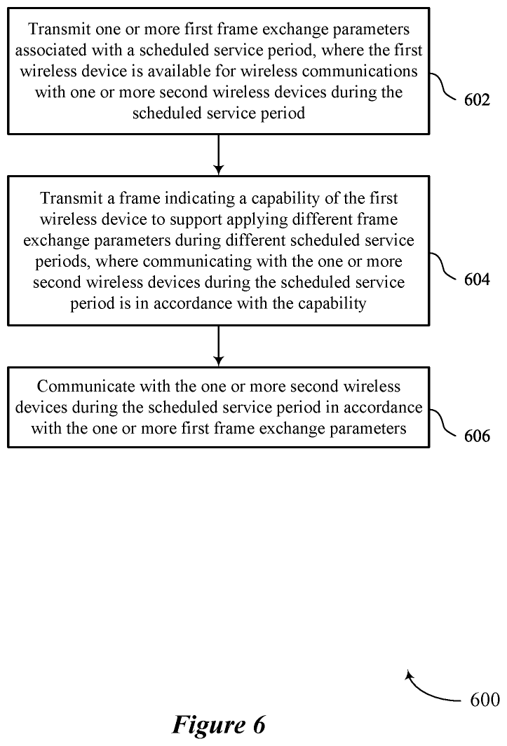

FIG. 3 shows an example of a process flow 300 that supports service period parameter scheduling for frame exchange procedures. The process flow 300 may implement or be implemented by aspects of the wireless communication network 100 and the communications timeline 200 as described with reference to FIGS. 1 and 6. For instance, in the example of FIG. 3, a first wireless device 302 may be in communication with a second wireless device 304 and a third wireless device 306, which may be examples of devices described herein with reference to FIG. 1 or FIG. 2. For example, the first wireless device 302 may be an example of an AP 102 or an AP 102-a, the second wireless device may be an example of a STA 104-a, and the third wireless device may be an example of a STA 104. In the following description of the process flow 300, the operations between the first wireless device 302, the second wireless device 304, and the third wireless device 306 may be performed in a different order than the example shown, or the operations between the first wireless device 302, the second wireless device 304, and the third wireless device 306 may be performed in different orders at different times. Some operations also may be omitted form the process flow 300, and other operations may be added to the process flow 300.

At 308, the first wireless device 302 may transmit one or more first frame exchange parameters associated with a scheduled service period. The first wireless device 302 may be available for wireless communications with one or more second wireless devices 304 during the scheduled service period. In some examples, the first wireless device 302 may receive the one or more first frame exchange parameters (such as from the one or more second wireless devices 304). In such examples, the first wireless device 302 may receive one or more of an upper limit of a frame exchange parameter of associated with the one or more first frame exchange parameters, or a lower limit of a frame exchange parameter of associated with the one or more first frame exchange parameters, or a combination thereof.

The first frame exchange parameters may include one or more of a quantity of spatial streams, a PPDU format, a PPDU duration, a bandwidth, a modulation and coding scheme, a transmit power, a transmit power, a MPDU start spacing, a quantity of MPDUs within an A-MPDU, A-MSDU utilization, fragmentation utilization, a quantity of padding, an (e)MLSR mode, an (e)MLMR mode, a STR mode, a NSTR mode, or any combination thereof. In some examples, the PPDU format may include one or more of an UHR PPDU, an extended range PPDU, an EHT PPDU, a HE PPDU, a HT PPDU, or any combination thereof.

At 310, the first wireless device 302 may communicate with the one or more second wireless devices 304 during the scheduled service period in accordance with the one or more first frame exchange parameters. In some examples, communicating with the one or more second wireless devices 304 may include exchanging one or more frames (such as data frame, control frame, management frame) with the one or more second wireless devices 304. Additionally, or alternatively, the first wireless device 302 may communicate with the one or more second wireless devices 304 according to a first operational mode. In such implementations, the first wireless device 302 enters the first operational mode in accordance with the one or more first frame exchange parameters.

For example, at 312, the first wireless device 302 may transmit a control frame during the scheduled service period in accordance with a capability of the first wireless device 302. The first wireless device 302 may transmit the control frame during the scheduled service period. The control frame may indicate a start (such as a starting time) of the first wireless device 302 using the one or more first frame exchange parameters during the scheduled service period.

In some other examples, at 314, the first wireless device 302 may receive a control frame during the scheduled service period in accordance with a capability of the first wireless device. The first wireless device 302 may receive the control frame during the scheduled service period and in accordance with the one or more first frame exchange parameters.

At 316, the first wireless device 302 may transmit a frame indicating a capability of the first wireless device 302 to support applying or enforcing different frame exchange parameters during different scheduled service periods. The first wireless device 302 may communicate with the one or more second wireless devices 304 during the scheduled service period in accordance with the capability. In some examples, the frame indicating the capability of the first wireless device 302 may be a management frame, an operation mode notification frame, or both.

At 318, the first wireless device 302 may receive a frame indicating a capability of a second wireless device 304 to support enforcing different frame exchange parameters during different scheduled service periods. The first wireless device 302 may communicate with the one or more second wireless devices 304 during the scheduled service period in accordance with the capability. In some examples, the frame indicating the capability of the second wireless device may be a management frame, an operation mode notification frame, or both.

In some examples, at 320, the first wireless device 302 may transmit a frame to the one or more second wireless devices 304 indicating an early termination of the scheduled service period. In some other examples, at 322, the first wireless device 302 may receiving a frame from the one or more second wireless devices indicating an early termination of the scheduled service period.

At 324, the first wireless device 302 may communicate with the one or more second wireless devices 304 using one or more second frame exchange parameters responsive to an early termination of the scheduled service period.

At 326, the first wireless device 302 may communicate with one or more third wireless devices 306 during a second period outside of the scheduled service period in accordance with one or more second frame exchange parameters. In some examples, a duration of the second period is defined in accordance with a capability of the first wireless device 302, a capability of a second wireless device 304, or both. The one or more third wireless devices 306 may operate according to a RAT that is different from a RAT associated with the first wireless device 302.

At 328, the first wireless device 302 may communicate with the second wireless device 304 using one or more third frame exchange parameters during a second scheduled service period. The one or more third frame exchange parameters may be the same as the one or more first frame exchange parameters or may be different from the one or more first frame exchange parameters.

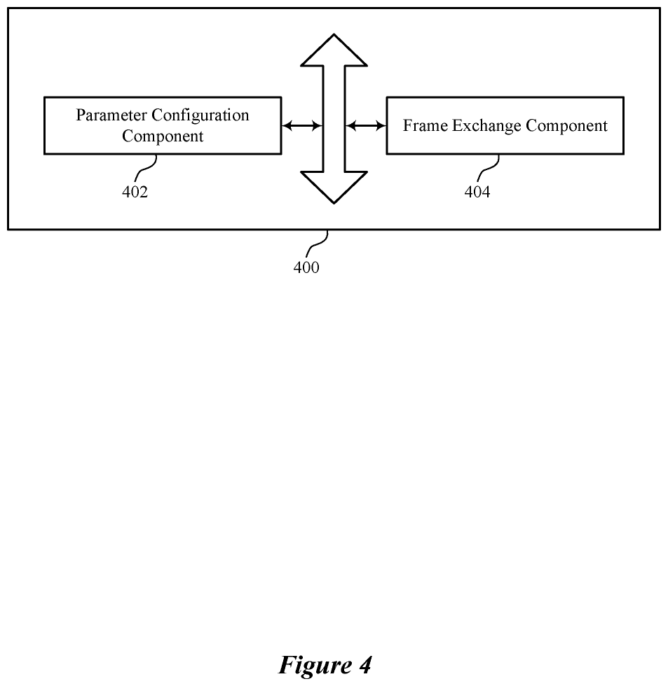

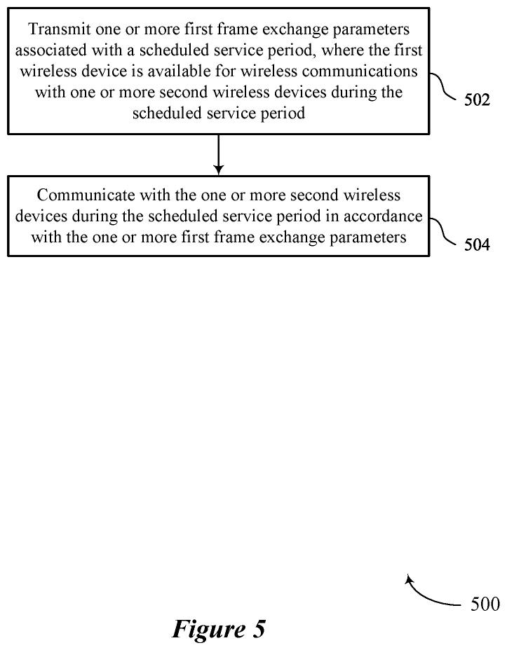

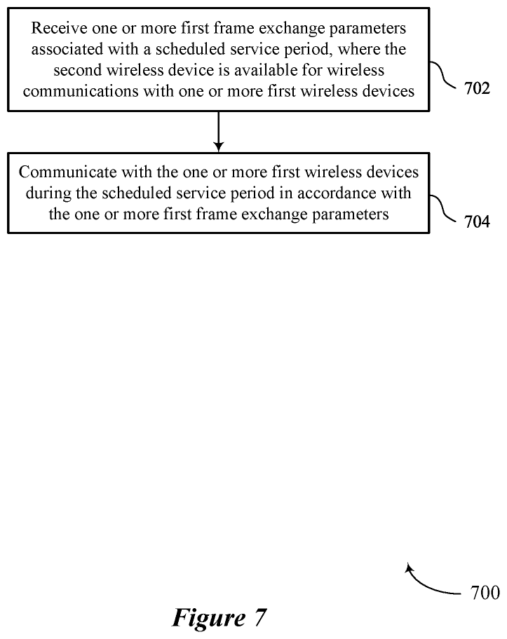

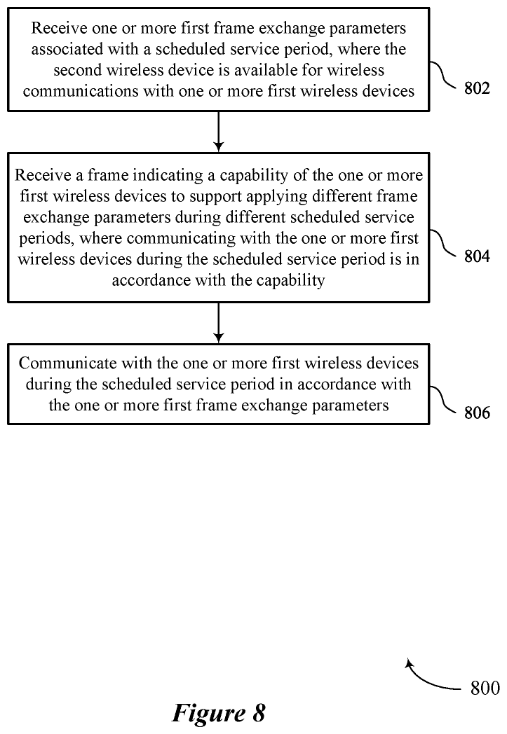

FIG. 4 shows a block diagram of an example wireless communication device 400 that supports service period parameter scheduling for frame exchange procedures. In some examples, the wireless communication device 400 is configured to perform the processes 500 and 600 described with reference to FIGS. 5 and 6, respectively. In some other examples, the wireless communication device 400 is configured to perform the processes 700 and 800 described with reference to FIGS. 7 and 8, respectively. The wireless communication device 400 may include one or more chips, SoCs, chipsets, packages, components, or devices that individually or collectively constitute or include a processing system. The processing system may interface with other components of the wireless communication device 400, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 400 may transmit the information output from the chip. In such an example, the second interface may refer to an interface between the processing system of the chip and a reception component, such that the wireless communication device 400 may receive information that is then passed to the processing system. In some such examples, the first interface also may obtain information, such as from the transmission component, and the second interface also may output information, such as to the reception component.

The processing system of the wireless communication device 400 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to cause the wireless communication device 400 to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to cause the wireless communication device 400 to perform various functions or operations described herein. Additionally, or alternatively, in some examples, one or more of the processors may be preconfigured to cause the wireless communication device 400 to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 400 can be configurable or configured for use in an AP, such as the AP 102 described with reference to FIG. 1. In some other examples, the wireless communication device 400 can be an AP that includes such a processing system and other components including multiple antennas. The wireless communication device 400 is capable of transmitting and receiving wireless communications in the form of, for example, wireless packets. For example, the wireless communication device 400 can be configurable or configured to transmit and receive packets in the form of physical layer PPDUs and MPDUs conforming to one or more of the IEEE 802.11 family of wireless communication protocol standards. In some other examples, the wireless communication device 400 can be configurable or configured to transmit and receive signals and communications conforming to one or more 3GPP specifications including those for 5G NR or 6G. In some examples, the wireless communication device 400 also includes or can be coupled with one or more application processors which may be further coupled with one or more other memories. In some examples, the wireless communication device 400 further includes at least one external network interface coupled with the processing system that enables communication with a core network or backhaul network that enables the wireless communication device 400 to gain access to external networks including the Internet.

The wireless communication device 400 includes a parameter configuration component 402 and a frame exchange component 404. Portions of one or more of the parameter configuration component 402 and the frame exchange component 404 may be implemented at least in part in hardware or firmware. For example, one or more of the parameter configuration component 402 and the frame exchange component 404 may be implemented at least in part by at least a processor or a modem. In some examples, portions of one or more of the parameter configuration component 402 and the frame exchange component 404 may be implemented at least in part by a processor and software in the form of processor-executable code stored in memory.

The wireless communication device 400 may support wireless communications in accordance with examples as disclosed herein. In some examples, the parameter configuration component 402 is configurable or configured to transmit one or more first frame exchange parameters associated with a scheduled service period, where the first wireless device is available for wireless communications with one or more second wireless devices during the scheduled service period. The frame exchange component 404 is configurable or configured to communicate with the one or more second wireless devices during the scheduled service period in accordance with the one or more first frame exchange parameters. In some other examples, the parameter configuration component 402 is configurable or configured to receive one or more first frame exchange parameters associated with a scheduled service period, where the second wireless device is available for wireless communications with one or more first wireless devices. The frame exchange component 404 may be configurable or configured to communicate with the one or more first wireless devices during the scheduled service period in accordance with the one or more first frame exchange parameters.

In some examples, to support communicating with the one or more second wireless devices, the frame exchange component 404 is configurable or configured to transmit a control frame during the scheduled service period in accordance with a capability of the first wireless device, where the first wireless device transmits the control frame during the scheduled service period and the control frame indicates a start of the first wireless device using the one or more first frame exchange parameters during the scheduled service period. In some other examples, the frame exchange component 404 may be configurable or configured to receive a control frame during the scheduled service period in accordance with a capability of the second wireless device, where the second wireless device receives the control frame during the scheduled service period and the control frame indicates a start of the second wireless device using the one or more first frame exchange parameters during the scheduled service period.

In some examples, to support communicating with the one or more second wireless devices, the frame exchange component 404 is configurable or configured to receive a control frame during the scheduled service period in accordance with a capability of the first wireless device, where the first wireless device receives the control frame during the scheduled service period and in accordance with the one or more first frame exchange parameters. In some other examples, the frame exchange component 404 may be configurable or configured to transmit a control frame during the scheduled service period in accordance with a capability of the second wireless device, where the second wireless device transmits the control frame during the scheduled service period and in accordance with the one or more first frame exchange parameters.

In some examples, the frame exchange component 404 is configurable or configured to transmit a frame indicating a capability of the first wireless device to support applying different frame exchange parameters during different scheduled service periods, where communicating with the one or more second wireless devices during the scheduled service period is in accordance with the capability. In some other examples, the frame exchange component 404 may be configurable or configured to receive a frame indicating a capability of the one or more second wireless devices to support applying different frame exchange parameters during different scheduled service periods, where communicating with the one or more second wireless devices during the scheduled service period is in accordance with the capability.

In some examples, the frame indicating the capability of the first wireless device is one or more of a management frame, an operation mode notification frame, or both.

In some examples, the frame exchange component 404 is configurable or configured to receive a frame indicating a capability of a second wireless device to support applying different frame exchange parameters during different scheduled service periods, where communicating with the one or more second wireless devices during the scheduled service period is in accordance with the capability. In some other examples, the frame exchange component 404 may be configurable or configured to transmit a frame indicating a capability of the one or more first wireless devices to support applying different frame exchange parameters during different scheduled service periods, where communicating with the one or more first wireless devices during the scheduled service period is in accordance with the capability.

In some examples, the frame indicating the capability of the second wireless device is one or more of a management frame, an operation mode notification frame, or both.

In some examples, the frame exchange component 404 is configurable or configured to communicate with the one or more second wireless devices according to a first operational mode, where the first wireless device enters the first operational mode in accordance with the one or more first frame exchange parameters. Alternatively, in some other examples, the frame exchange component 404 may be configurable or configured to communicate with the first wireless device according to a first operational mode, where the second wireless device enters the first operational mode in accordance with the one or more first frame exchange parameters.

In some examples, the frame exchange component 404 is configurable or configured to communicate with one or more third wireless devices during a second period outside of the scheduled service period in accordance with one or more second frame exchange parameters, where a duration of the second period is defined in accordance with a capability of the first wireless device, a capability of a second wireless device, or both.

In some examples, the one or more third wireless devices operate according to a RAT that is different from a RAT associated with the first wireless device.

In some examples, the frame exchange component 404 is configurable or configured to communicate using one or more third frame exchange parameters during a second scheduled service period.

In some examples, to support communicating with the one or more second wireless devices during the scheduled service period, the frame exchange component 404 is configurable or configured to transmit a frame to the one or more second wireless devices indicating an early termination of the scheduled service period. In some other examples, to support communicating with the first wireless device during the scheduled service period, the frame exchange component 404 may be configurable or configured to receive a frame from the one or more first wireless devices indicating an early termination of the scheduled service period.

In some examples, the frame exchange component 404 is configurable or configured to receive a frame from the one or more second wireless devices indicating an early termination of the scheduled service period. In some other examples, the frame exchange component 404 may be configurable or configured to transmit a frame to the one or more first wireless devices indicating an early termination of the scheduled service period.

In some examples, the frame exchange component 404 is configurable or configured to communicate using one or more second frame exchange parameters responsive to an early termination of the scheduled service period.

In some examples, the one or more first frame exchange parameters may include one or more of: a quantity of spatial streams, a physical protocol data unit (PPDU) format, a PPDU duration, a bandwidth, a modulation and code scheme, a transmit power, a transmit power, a MPDU start spacing, a quantity of MPDUs within an A-MPDU, A-MSDU utilization, fragmentation utilization, a quantity of padding, an (e)MLSR mode, an (e)MLMR mode, a STR mode, a NSTR mode, or any combination thereof.

In some examples, the PPDU format may include one or more of an UHR PPDU, an extended range PPDU, an EHT PPDU, a HE PPDU, a HT PPDU, or any combination thereof.

In some examples, to support receiving the one or more first frame exchange parameters, the frame exchange component 404 is configurable or configured to receive one or more of: an upper limit of a frame exchange parameter of the one or more first frame exchange parameters, or a lower limit of a frame exchange parameter of the one or more first frame exchange parameters, or a combination thereof. In some other examples, the frame exchange component 404 may be configurable or configured to transmit one or more of: an upper limit of a frame exchange parameter of the one or more first frame exchange parameters, or a lower limit of a frame exchange parameter of the one or more first frame exchange parameters, or a combination thereof.

FIG. 5 shows a flowchart illustrating an example process 500 performable by or at a first wireless device that supports service period parameter scheduling for frame exchange procedures. The operations of the process 500 may be implemented by a first wireless device or its components as described herein. For example, the process 500 may be performed by a wireless communication device, such as the wireless communication device 400 described with reference to FIG. 4, operating as or within a wireless AP. In some examples, the process 500 may be performed by a wireless AP, such as one of the APs 102 described with reference to FIG. 1.

In some examples, in block 502, the first wireless device may transmit one or more first frame exchange parameters associated with a scheduled service period, where the first wireless device is available for wireless communications with one or more second wireless devices during the scheduled service period. The operations of block 502 may be performed in accordance with examples as disclosed herein. In some implementations, aspects of the operations of block 502 may be performed by a parameter configuration component 402 as described with reference to FIG. 4.

In some examples, in block 504, the first wireless device may communicate with the one or more second wireless devices during the scheduled service period in accordance with the one or more first frame exchange parameters. The operations of block 504 may be performed in accordance with examples as disclosed herein. In some implementations, aspects of the operations of block 504 may be performed by a frame exchange component 404 as described with reference to FIG. 4.

FIG. 6 shows a flowchart illustrating an example process 600 performable by or at a first wireless device that supports service period parameter scheduling for frame exchange procedures. The operations of the process 600 may be implemented by a first wireless device or its components as described herein. For example, the process 600 may be performed by a wireless communication device, such as the wireless communication device 400 described with reference to FIG. 4, operating as or within a wireless AP. In some examples, the process 600 may be performed by a wireless AP, such as one of the APs 102 described with reference to FIG. 1.

In some examples, in block 602, the first wireless device may transmit one or more first frame exchange parameters associated with a scheduled service period, where the first wireless device is available for wireless communications with one or more second wireless devices during the scheduled service period. The operations of block 602 may be performed in accordance with examples as disclosed herein. In some implementations, aspects of the operations of block 602 may be performed by a parameter configuration component 402 as described with reference to FIG. 4.

In some examples, in block 604, the first wireless device may transmit a frame indicating a capability of the first wireless device to support applying different frame exchange parameters during different scheduled service periods, where communicating with the one or more second wireless devices during the scheduled service period is in accordance with the capability. The operations of block 604 may be performed in accordance with examples as disclosed herein. In some implementations, aspects of the operations of block 604 may be performed by a frame exchange component 404 as described with reference to FIG. 4.

In some examples, in block 606, the first wireless device may communicate with the one or more second wireless devices during the scheduled service period in accordance with the one or more first frame exchange parameters. The operations of block 606 may be performed in accordance with examples as disclosed herein. In some implementations, aspects of the operations of block 606 may be performed by a frame exchange component 404 as described with reference to FIG. 4.

FIG. 7 shows a flowchart illustrating an example process 700 performable by or at a second wireless device that supports service period parameter scheduling for frame exchange procedures. The operations of the process 700 may be implemented by a second wireless device or its components as described herein. For example, the process 700 may be performed by a wireless communication device, such as the wireless communication device 400 described with reference to FIG. 4, operating as or within a wireless STA. In some examples, the process 700 may be performed by a wireless STA, such as one of the STAs 104 described with reference to FIG. 1.

In some examples, in block 702, the second wireless device may receive one or more first frame exchange parameters associated with a scheduled service period, where the second wireless device is available for wireless communications with one or more first wireless devices. The operations of block 702 may be performed in accordance with examples as disclosed herein. In some implementations, aspects of the operations of block 702 may be performed by a parameter configuration component 402 as described with reference to FIG. 4.

In some examples, in block 704, the second wireless device may communicate with the one or more first wireless devices during the scheduled service period in accordance with the one or more first frame exchange parameters. The operations of block 704 may be performed in accordance with examples as disclosed herein. In some implementations, aspects of the operations of block 704 may be performed by a frame exchange component 404 as described with reference to FIG. 4.

FIG. 8 shows a flowchart illustrating an example process 800 performable by or at a second wireless device that supports service period parameter scheduling for frame exchange procedures. The operations of the process 800 may be implemented by a second wireless device or its components as described herein. For example, the process 800 may be performed by a wireless communication device, such as the wireless communication device 400 described with reference to FIG. 4, operating as or within a wireless STA. In some examples, the process 800 may be performed by a wireless STA, such as one of the STAs 104 described with reference to FIG. 1.

In some examples, in block 802, the second wireless device may receive one or more first frame exchange parameters associated with a scheduled service period, where the second wireless device is available for wireless communications with one or more first wireless devices. The operations of block 802 may be performed in accordance with examples as disclosed herein. In some implementations, aspects of the operations of block 802 may be performed by a parameter configuration component 402 as described with reference to FIG. 4.

In some examples, in block 804, the second wireless device may receive a frame indicating a capability of the one or more first wireless devices to support applying different frame exchange parameters during different scheduled service periods, where communicating with the one or more first wireless devices during the scheduled service period is in accordance with the capability. The operations of block 804 may be performed in accordance with examples as disclosed herein. In some implementations, aspects of the operations of block 804 may be performed by a frame exchange component 404 as described with reference to FIG. 4.

In some examples, in block 806, the second wireless device may communicate with the one or more first wireless devices during the scheduled service period in accordance with the one or more first frame exchange parameters. The operations of block 806 may be performed in accordance with examples as disclosed herein. In some implementations, aspects of the operations of block 806 may be performed by a frame exchange component 404 as described with reference to FIG. 4.

Implementation examples are described in the following numbered clauses:

Aspect 1: A method for wireless communications at a first wireless device, including: transmitting one or more first frame exchange parameters associated with a scheduled service period, where the first wireless device is available for wireless communications with one or more second wireless devices during the scheduled service period; and communicating with the one or more second wireless devices during the scheduled service period in accordance with the one or more first frame exchange parameters.

Aspect 2: The method of aspect 1, where communicating with the one or more second wireless devices further includes: transmitting a control frame during the scheduled service period in accordance with a capability of the first wireless device, where the first wireless device transmits the control frame during the scheduled service period and the control frame indicates a start of the first wireless device using the one or more first frame exchange parameters during the scheduled service period.

Aspect 3: The method of any of aspects 1 through 2, where communicating with the one or more second wireless devices further includes: receiving a control frame during the scheduled service period in accordance with a capability of the first wireless device, where the first wireless device receives the control frame during the scheduled service period and in accordance with the one or more first frame exchange parameters.

Aspect 4: The method of any of aspects 1 through 3, further including: transmitting a frame indicating a capability of the first wireless device to support applying different frame exchange parameters during different scheduled service periods, where communicating with the one or more second wireless devices during the scheduled service period is in accordance with the capability.

Aspect 5: The method of aspect 4, where the frame indicating the capability of the first wireless device is one or more of a management frame, an operation mode notification frame, or both.

Aspect 6: The method of any of aspects 1 through 5, further including: receiving a frame including indicating a capability of a second wireless device to support applying different frame exchange parameters during different scheduled service periods, where communicating with the one or more second wireless devices during the scheduled service period is in accordance with the capability.

Aspect 7: The method of aspect 6, where the frame indicating the capability of the second wireless device is one or more of a management frame, an operation mode notification frame, or both.

Aspect 8: The method of any of aspects 1 through 7, further including: communicating with the one or more second wireless devices according to a first operational mode, where the first wireless device enters the first operational mode in accordance with the one or more first frame exchange parameters.

Aspect 9: The method of any of aspects 1 through 8, further including: communicating with one or more third wireless devices during a second period outside of the scheduled service period in accordance with one or more second frame exchange parameters, where a duration of the second period is defined in accordance with a capability of the first wireless device, a capability of a second wireless device, or both.

Aspect 10: The method of aspect 9, where the one or more third wireless devices operate according to a RAT that is different from a RAT associated with the first wireless device.

Aspect 11: The method of any of aspects 1 through 10, further including: communicating using one or more third frame exchange parameters during a second scheduled service period.

Aspect 12: The method of any of aspects 1 through 11, where communicating with the one or more second wireless devices during the scheduled service period includes: transmitting a frame to the one or more second wireless devices indicating an early termination of the scheduled service period.

Aspect 13: The method of any of aspects 1 through 12, further including: receiving a frame from the one or more second wireless devices indicating an early termination of the scheduled service period.

Aspect 14: The method of any of aspects 1 through 13, further including: communicating using one or more second frame exchange parameters responsive to an early termination of the scheduled service period.

Aspect 15: The method of any of aspects 1 through 14, where the one or more first frame exchange parameters includes one or more of a quantity of spatial streams, a physical protocol data unit (PPDU) format, a PPDU duration, a bandwidth, a modulation and coding scheme, a transmit power, a transmit power, a medium access control protocol data unit (MPDU) start spacing, a quantity of MPDUs within an aggregate MPDU (A-MPDU), aggregate medium access control service data unit (A-MSDU) utilization, fragmentation utilization, a quantity of padding, an enhanced multi-link single radio ((e)MLSR) mode, an enhanced multi-link multi-radio ((e)MLMR) mode, a simultaneous transceiver (STR) mode, a non-simultaneous transceiver (NSTR) mode, or any combination thereof.

Aspect 16: The method of aspect 15, where the PPDU format includes one or more of an ultra-high-reliability (UHR) PPDU, an extended range PPDU, an extremely-high-throughput (EHT) PPDU, a high-efficiency (HE) PPDU, a high-throughput (HT) PPDU, or any combination thereof.

Aspect 17: The method of any of aspects 1 through 16, where receiving the one or more first frame exchange parameters includes: receiving one or more of: an upper limit of a frame exchange parameter of the one or more first frame exchange parameters, or a lower limit of a frame exchange parameter of the one or more first frame exchange parameters, or a combination thereof.

Aspect 18: A method for wireless communications at a second wireless device, including: receiving one or more first frame exchange parameters associated with a scheduled service period, where the second wireless device is available for wireless communications with one or more first wireless devices; and communicating with the one or more first wireless devices during the scheduled service period in accordance with the one or more first frame exchange parameters.

Aspect 19: The method of aspect 18, where communicating with the one or more first wireless devices further includes: receiving a control frame during the scheduled service period in accordance with a capability of the second wireless device, where the second wireless device receives the control frame during the scheduled service period and the control frame indicates a start of the second wireless device using the one or more first frame exchange parameters during the scheduled service period.

Aspect 20: The method of any of aspects 18 through 19, where communicating with the one or more first wireless devices further includes: transmitting a control frame during the scheduled service period in accordance with a capability of the second wireless device, where the second wireless device transmits the control frame during the scheduled service period and in accordance with the one or more first frame exchange parameters.

Aspect 21: The method of any of aspects 18 through 20, further including: receiving a frame indicating a capability of the one or more first wireless devices to support applying different frame exchange parameters during different scheduled service periods, where communicating with the one or more first wireless devices during the scheduled service period is in accordance with the capability.

Aspect 22: The method of aspect 21, where the frame indicating the capability of the one or more first wireless devices is one or more of a management frame, an operation mode notification frame, or both.

Aspect 23: The method of any of aspects 18 through 22, further including: transmitting a frame indicating a capability of the one or more first wireless devices to support applying different frame exchange parameters during different scheduled service periods, where communicating with the one or more first wireless devices during the scheduled service period is in accordance with the capability.

Aspect 24: The method of aspect 23, where the frame indicating the capability of the second wireless device is one or more of a management frame, an operation mode notification frame, or both.

Aspect 25: The method of any of aspects 18 through 24, further including: communicating with the one or more first wireless devices according to a first operational mode, where the second wireless device enters the first operational mode in accordance with the one or more first frame exchange parameters.

Aspect 26: The method of any of aspects 18 through 25, further including: communicating with one or more third wireless devices during a second period outside of the scheduled service period in accordance with one or more second frame exchange parameters, where a duration of the second period is defined in accordance with a capability of the second wireless device, a capability of the one or more first wireless devices, or both.

Aspect 27: The method of aspect 26, where the one or more third wireless devices operate according to a RAT that is different from a RAT associated with the second wireless device.

Aspect 28: The method of any of aspects 18 through 27, further including: communicating using one or more third frame exchange parameters during a second scheduled service period.

Aspect 29: The method of any of aspects 18 through 28, where communicating with the one or more first wireless devices during the scheduled service period includes: receiving a frame from the one or more first wireless devices indicating an early termination of the scheduled service period.

Aspect 30: The method of any of aspects 18 through 29, further including: transmitting a frame to the one or more first wireless devices indicating an early termination of the scheduled service period.

Aspect 31: The method of any of aspects 18 through 30, further including: communicating using one or more second frame exchange parameters responsive to an early termination of the scheduled service period.

Aspect 32: The method of any of aspects 18 through 31, where the one or more first frame exchange parameters includes one or more of a quantity of spatial streams, a physical protocol data unit (PPDU) format, a bandwidth, a modulation and coding scheme, a transmit power, a medium access control protocol data unit (MPDU) start spacing, a quantity of MPDUs within an aggregate MPDU (A-MPDU), aggregate medium access control service data unit (A-MSDU) utilization, fragmentation utilization, a quantity of padding, an enhanced multi-link single radio ((e)MLSR) mode, an enhanced multi-link multi-radio ((e)MLMR) mode, a simultaneous transceiver (STR) mode, a non-simultaneous transceiver (NSTR) mode, or any combination thereof.

Aspect 33: The method of aspect 32, where the PPDU format includes one or more of an ultra-high-reliability (UHR) PPDU, an extended range PPDU, an extremely-high-throughput (EHT) PPDU, a high-efficiency (HE) PPDU, a high-throughput (HT) PPDU, or any combination thereof.

Aspect 34: The method of any of aspects 18 through 33, where transmitting the one or more first frame exchange parameters includes: transmitting one or more of: an upper limit of a frame exchange parameter of the one or more first frame exchange parameters, or a lower limit of a frame exchange parameter of the one or more first frame exchange parameters, or a combination thereof.

Aspect 35: A first wireless device for wireless communications, including one or more memories storing processor-executable code, and one or more processors coupled with the one or more memories and individually or collectively operable to execute the code to cause the first wireless device to perform a method of any of aspects 1 through 17.

Aspect 36: A first wireless device for wireless communications, including at least one means for performing a method of any of aspects 1 through 17.

Aspect 37: A non-transitory computer-readable medium storing code for wireless communications, the code including instructions executable by a processor to perform a method of any of aspects 1 through 17.

Aspect 38: A second wireless device for wireless communications, including one or more memories storing processor-executable code, and one or more processors coupled with the one or more memories and individually or collectively operable to execute the code to cause the second wireless device to perform a method of any of aspects 18 through 34.

Aspect 39: A second wireless device for wireless communications, including at least one means for performing a method of any of aspects 18 through 34.

Aspect 40: A non-transitory computer-readable medium storing code for wireless communications, the code including instructions executable by a processor to perform a method of any of aspects 18 through 34.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described herein. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described herein as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described herein should not be understood as requiring such separation in all examples, and it should be understood that the described program components and systems can generally be integrated together in a single software product or packaged into multiple software products.

What is claimed is:

1. A first wireless device, comprising:
a processing system that includes processor circuitry and memory circuitry that stores code, the processing system configured to cause the first wireless device to:
transmit one or more first frame exchange parameters associated with a scheduled service period, wherein the first wireless device is available for wireless communications with one or more second wireless devices during the scheduled service period; and
communicate with the one or more second wireless devices during the scheduled service period in accordance with the one or more first frame exchange parameters.

2. The first wireless device of claim 1, wherein, to communicate with the one or more second wireless devices, the processing system is further configured to cause the first wireless device to:
transmit a control frame during the scheduled service period in accordance with a capability of the first wireless device, wherein the first wireless device transmits the control frame during the scheduled service period and the control frame indicates a start of the first wireless device using the one or more first frame exchange parameters during the scheduled service period.

3. The first wireless device of claim 1, wherein, to communicate with the one or more second wireless devices, the processing system is further configured to cause the first wireless device to:
receive a control frame during the scheduled service period in accordance with a capability of the first wireless device, wherein the first wireless device receives the control frame during the scheduled service period and in accordance with the one or more first frame exchange parameters.

4. The first wireless device of claim 1, wherein the processing system is further configured to cause the first wireless device to:
transmit a frame indicating a capability of the first wireless device to support applying different frame exchange parameters during different scheduled service periods, wherein communicating with the one or more second wireless devices during the scheduled service period is in accordance with the capability.

5. The first wireless device of claim 1, wherein the processing system is further configured to cause the first wireless device to:
receive a frame indicating a capability of a second wireless device to support applying different frame exchange parameters during different scheduled service periods, wherein communicating with the one or more second wireless devices during the scheduled service period is in accordance with the capability.

6. The first wireless device of claim 1, wherein the processing system is further configured to cause the first wireless device to:
communicate with the one or more second wireless devices according to a first operational mode, wherein the first wireless device enters the first operational mode in accordance with the one or more first frame exchange parameters.

7. The first wireless device of claim 1, wherein the processing system is further configured to cause the first wireless device to:
communicate with one or more third wireless devices during a second period outside of the scheduled service period and in accordance with one or more second frame exchange parameters, wherein a duration of the second period is defined in accordance with a capability of the first wireless device, a capability of a second wireless device, or both.

8. The first wireless device of claim 1, wherein, to communicate with the one or more second wireless devices during the scheduled service period, the processing system is configured to cause the first wireless device to:
transmit a frame to the one or more second wireless devices indicating an early termination of the scheduled service period.

9. The first wireless device of claim 1, wherein the processing system is further configured to cause the first wireless device to:
receive a frame from the one or more second wireless devices indicating an early termination of the scheduled service period.

10. The first wireless device of claim 1, wherein the processing system is further configured to cause the first wireless device to:
communicate using one or more second frame exchange parameters responsive to an early termination of the scheduled service period.

11. A second wireless device, comprising:
a processing system that includes processor circuitry and memory circuitry that stores code, the processing system configured to cause the second wireless device to:
receive one or more first frame exchange parameters associated with a scheduled service period, wherein the second wireless device is available for wireless communications with one or more first wireless devices; and
communicate with the one or more first wireless devices during the scheduled service period in accordance with the one or more first frame exchange parameters.

12. The second wireless device of claim 11, wherein, to communicate with the one or more first wireless devices, the processing system is further configured to cause the second wireless device to:
receive a control frame during the scheduled service period in accordance with a capability of the second wireless device, wherein the second wireless device receives the control frame during the scheduled service period and the control frame indicates a start of the second wireless device using the one or more first frame exchange parameters during the scheduled service period.

13. The second wireless device of claim 11, wherein, to communicate with the one or more first wireless devices, the processing system is further configured to cause the second wireless device to:
transmit a control frame during the scheduled service period in accordance with a capability of the second wireless device, wherein the second wireless device transmits the control frame during the scheduled service period and in accordance with the one or more first frame exchange parameters.

14. The second wireless device of claim 11, wherein the processing system is further configured to cause the second wireless device to:
receive a frame indicating a capability of a first wireless device to support applying different frame exchange parameters during different scheduled service periods, wherein communicating with the one or more first wireless devices during the scheduled service period is in accordance with the capability.

15. The second wireless device of claim 11, wherein the processing system is further configured to cause the second wireless device to:
transmit a frame indicating a capability of the second wireless device to support applying different frame exchange parameters during different scheduled service periods, wherein communicating with the one or more first wireless devices during the scheduled service period is in accordance with the capability.

16. The second wireless device of claim 11, wherein the processing system is further configured to cause the second wireless device to:
communicate with the one or more first wireless devices according to a first operational mode, wherein the second wireless device enters the first operational mode in accordance with the one or more first frame exchange parameters.

17. The second wireless device of claim 11, wherein the processing system is further configured to cause the second wireless device to:
communicate with one or more third wireless devices during a second period outside of the scheduled service period and in accordance with one or more second frame exchange parameters, wherein a duration of the second period is defined in accordance with a capability of the second wireless device, a capability of the one or more first wireless devices, or both.

18. The second wireless device of claim 11, wherein, to communicate with the one or more first wireless devices during the scheduled service period, the processing system is configured to cause the second wireless device to:
receive a frame from the one or more first wireless devices indicating an early termination of the scheduled service period.

19. The second wireless device of claim 11, wherein the processing system is further configured to cause the second wireless device to:
transmit a frame to the one or more first wireless devices indicating an early termination of the scheduled service period.

20. The second wireless device of claim 11, wherein the processing system is further configured to cause the second wireless device to:
communicate using one or more second frame exchange parameters responsive to an early termination of the scheduled service period.

21. A method for wireless communications at a first wireless device, comprising:
transmitting one or more first frame exchange parameters associated with a scheduled service period, wherein the first wireless device is available for wireless communications with one or more second wireless devices during the scheduled service period; and
communicating with the one or more second wireless devices during the scheduled service period in accordance with the one or more first frame exchange parameters.

22. The method of claim 21, wherein communicating with the one or more second wireless devices further comprises:
transmitting a control frame during the scheduled service period in accordance with a capability of the first wireless device, wherein the first wireless device transmits the control frame during the scheduled service period and the control frame indicates a start of the first wireless device using the one or more first frame exchange parameters during the scheduled service period.

23. The method of claim 21, wherein communicating with the one or more second wireless devices further comprises:
receiving a control frame during the scheduled service period in accordance with a capability of the first wireless device, wherein the first wireless device receives the control frame during the scheduled service period and in accordance with the one or more first frame exchange parameters.

24. The method of claim 21, further comprising:
transmitting a frame indicating a capability of the first wireless device to support applying different frame exchange parameters during different scheduled service periods, wherein communicating with the one or more second wireless devices during the scheduled service period is in accordance with the capability.

25. The method of claim 21, further comprising:
receiving a frame indicating a capability of a second wireless device to support applying different frame exchange parameters during different scheduled service periods, wherein communicating with the one or more second wireless devices during the scheduled service period is in accordance with the capability.

26. A method for wireless communications at a second wireless device, comprising:
receiving one or more first frame exchange parameters associated with a scheduled service period, wherein the second wireless device is available for wireless communications with one or more first wireless devices; and
communicating with the one or more first wireless devices during the scheduled service period in accordance with the one or more first frame exchange parameters.

27. The method of claim 26, wherein communicating with the one or more first wireless devices further comprises:
receiving a control frame during the scheduled service period in accordance with a capability of the second wireless device, wherein the second wireless device receives the control frame during the scheduled service period and the control frame indicates a start of the second wireless device using the one or more first frame exchange parameters during the scheduled service period.

28. The method of claim 26, wherein communicating with the one or more first wireless devices further comprises:
transmitting a control frame during the scheduled service period in accordance with a capability of the second wireless device, wherein the second wireless device transmits the control frame during the scheduled service period and in accordance with the one or more first frame exchange parameters.

29. The method of claim 26, further comprising:
receiving a frame indicating a capability of a first wireless device to support applying different frame exchange parameters during different scheduled service periods, wherein communicating with the one or more first wireless devices during the scheduled service period is in accordance with the capability.

30. The method of claim 26, further comprising:
transmitting a frame indicating a capability of the second wireless device to support applying different frame exchange parameters during different scheduled service periods, wherein communicating with the one or more first wireless devices during the scheduled service period is in accordance with the capability.
